(19) United States
(12) Patent Application Publication
(10) Pub. No.: US 2007/0027833 A1
(43) Pub. Date: Feb. 1, 2007

(54) Computer program and method for retrieving information from a database

(76) Inventors: Maxwell S. Matthews, Birmingham, MI (US); Christopher Falberg, Waterford, MI (US)

Correspondence Address: Arnold S. Weintraub;The Weintraub Group, P.L.C., Suite 240, 32000 Northwestern Highway, Farmington Hills, MI, 48334, US

(21) Appl. No.: 11/491,706

(22) Filed: Jul. 24, 2006

Related U.S. Application Data
(60) Provisional application No. 60/702,075, filed on Jul. 22, 2005.

(51) Int. Cl. G06F 17/30

(52) U.S. Cl. 707/1

(57) ABSTRACT

Disclosed herein is a program and method for retrieving information from a database. A request module executes a request for information from the database, where the request includes at least one database procedure. A library module receives the request and containing instructions to execute at least one procedure received from the request module. The program and method eliminates the need for changes to a library module when a new feature, page, routine or procedure is added to the application. Additionally the program and method can efficiently reformat data queried from a database system.

### CROSS-REFERENCE TO RELATED APPLICATIONS

This application is a completion application of co-pending U.S. Provisional Patent Application Ser. No. 60/702,075 dated Jul. 22, 2005, the entire disclosure of which is hereby incorporated by reference.

### BACKGROUND OF THE INVENTION

I. Field of the Invention

The present invention relates to a computer program for a database, and more specifically, to a computer program for retrieving information from a database.

II. Background of the Invention

Software applications have become a popular medium by which to conduct business and retrieve information. Software applications, typically, use a database to contain, retain and organize information. A database may store information such as data, music, video, images and text. Typically the information is organized into fields, e.g. columns and tables. Information may be structured in a database in a number of ways, such as by a hierarchical model, where a fact is associated with each piece of data, or relational model, where the data satisfies a logical predicate.

The software used to manage and query a database is known as a database management system.

In the field of computer application development, many times a database is utilized as the ‘back end” to retrieve and store information. A number of option screens are designed to provide specific information or execute specific functions that retrieve information from the database. As developers create a new application or modify an existing application to add new features, modifications are made to the application software as well as to the database. A server based system, for example, will typically utilize a script to execute other programs, modules or functions that may be located outside of the program or on another server. As such, the server-based application software must execute commands to query information from the database. The database management system must also be modified to cooperate with the application.

As is known to those skilled in the art to which the present invention pertains, heretofore, according to present application software creation procedures, each time a query is to be sent regarding a specific data point, it requires the writing of a string of code. Regardless of the different database modules or database management system which one wanted to access, this string of code has to be written. Typically, the writing is done by the software developer with a computer using the formulae on or under the screen, i.e. embedded code.

Each database management system contains its own predefined query and management system. Often times a developer will desire a different output format than the format and relationships provided by the database management system. Often specific pages are developed in a single system that are job specific. For example, an automobile parts specialist will require different information and organization than a purchasing agent. Depending on the type of feature, routine or function requesting the query, a different data format and relationships are delivered.

Thus, it is desirable to provide a computer program that can efficiently reformat data queried from a database system. Furthermore, it is desirable to eliminate the need to write a string of code each time a modification is made to a database or when a new feature, page, routine or procedure is added to the application.

As detailed below, the present invention provides a simplified means for creating or writing software i.e. means for facilitating computer software application development.

### SUMMARY OF THE INVENTION

The present invention, in a first aspect, facilitates application software development by ascribing a pre-definition to each data point or data field. By providing a pre-definition to a data point(s) or data field(s) and storing it or them in a request module, the need to write a string of code for each request or query relative thereto is eliminated.

In a second aspect hereof, a computer program for retrieving information from a database comprises a request module for executing a request for information from a database, where the request includes at least one database procedure. A library module receives the request, the library module contains instructions to execute at least one procedure received from the request module. The library module obtains data from the database, transforms obtained data based upon instructions from a first data format module stored in the library module, and returns the transformed data to the request module.

Additionally, the request module transforms data received from the library module based upon instructions from a second data format module stored therewithin to create hierarchical relationships and attributes based upon received data fields. The request module may also transform data based upon instructions from a third data format module, similarly stored therewithin, to create a page layout based upon a request page. The procedure received by the library module contains at least one database query.

The first data format module may contain instructions to remove unnecessary data obtained by a query, add data identifiers, provide statistical information and arrange fields.

Additionally, the present invention provides a method for retrieving information from a database which comprises the steps of: (a) executing a request for information stored in a database, where the request includes at least one or more database procedures, (b) processing the request by executing each procedure and obtaining data from the database, (c) transforming obtained data based upon instructions from a first data format module, (d) continuing to process procedures until all procedures have been processed and returning the transformed data to a display.

The display may be a networked computer screen, website or the like.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is a block diagram generally illustrating an exemplary graphic user interface for an application employing the present invention;

FIG. 2 is a simplified architectural block diagram of an embodiment of the computer program of the present invention;

FIG. 3 is a simplified process flow diagram illustrating the request module in accordance with the principles of the present invention;

FIG. 4 is a simplified process flow diagram illustrating the library module in accordance with the principles of the present invention;

FIG. 5 is a process flow diagram in accordance with a method for retrieving information from a database in accordance with the principles of the present invention;

FIG. 6 is a flow chart of illustrating the flow of data using pre-definitions, and

FIG. 7 is a flow chart of the conventional method employed prior to the present invention for obtaining data.

### DESCRIPTION OF THE PREFERRED EMBODIMENT

At the outset hereof, it should be noted that the present invention has particular utility in application software development involving retrieving data from a database and displaying it on a website, or computer screen of a network and the like. The present invention enables the computer software developer to effectively and efficiently not only create the software but to have the data effectively transferred to the screen in a much more efficient and effective manner without necessitating the rewriting of code each and every time a new feature of that data point is added or deleted therefrom.

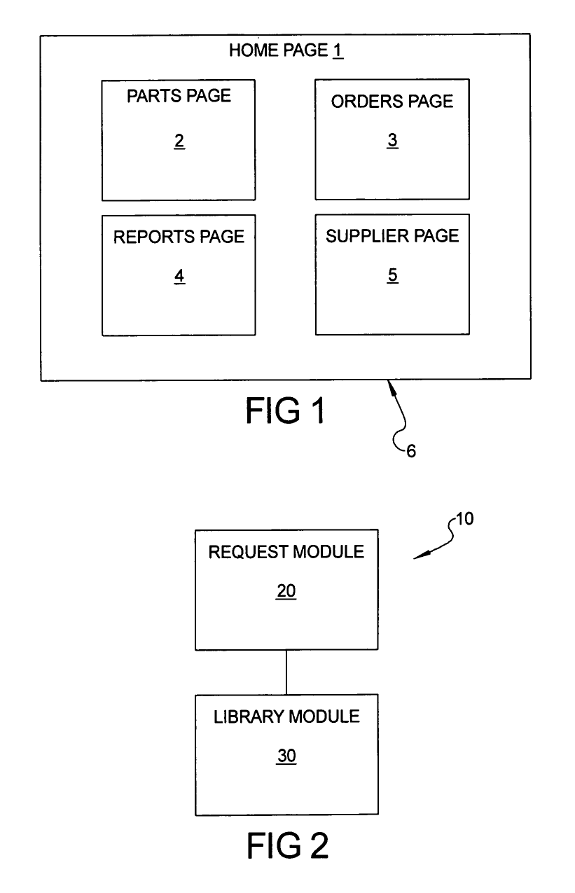

Referring now to FIGS. 1-6, the present invention is illustrated as being implemented in a suitable computing environment. Although not required, the invention will be described in the general context of executable instructions, such as program modules, being executed by one or more computers. Generally, program modules may include code segments, processes, scripts, routines, programs, objects, components, data structures, etc. that perform particular tasks or processes. Those skilled in the art will appreciate that the invention may be practiced with a variety of computer systems, including in distributed computing environments where tasks are performed by remote processing devices that are linked through a communications network. In a distributed computing environment, program modules may be located in both local and remote memory storage devices.

An exemplary computer system for implementing the invention includes a general purpose computing device in the form of a server, including a processor, memory, and a bus device that couples various components including the memory to the processor. The bus may be any of several types of bus structures including a memory bus or memory controller, a peripheral bus, and a local bus using any of a variety of bus architectures. The memory includes read only memory (ROM) and random access memory (RAM). The computer may include a hard disk-drive for reading from and writing to a hard disk, a magnetic disk drive for reading from or writing to a removable magnetic media, an optical disk for reading from or writing to a removable optical media, such as a CD ROM, or other optical media. A monitor or other type of display device is also connected to the system via an interface, such as a video adapter.

A hard disk drive, magnetic disk drive, and/or optical disk drive may be connected to a bus by an interface. The drives and their associated computer-readable media provide nonvolatile storage of computer readable instructions, data structures, program modules and other data for the computer. Although the exemplary environment described herein employs a hard disk, it will be appreciated by those skilled in the art that other types of computer readable media which can store data that is accessible by a computer may also be used in the exemplary operating environment.

A number of program modules may be stored on the hard disk, magnetic disk, optical disk, ROM or RAM, including an operating system, one or more applications programs, other program modules, and program data. Additionally, one or more database programs are installed on a computer readable media.

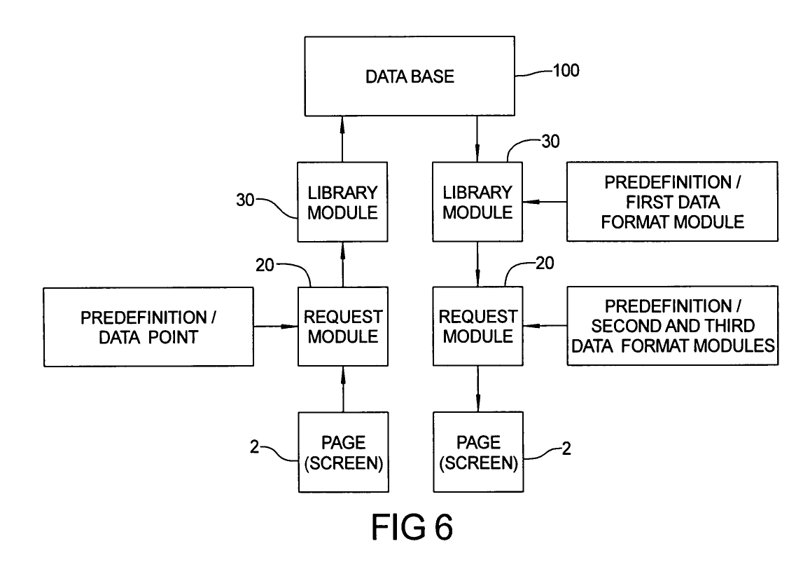

With particular reference to FIGS. 1 and 6, a block diagram is shown generally illustrating an exemplary graphic user interface 6 for an application employing the present invention. In the present example, home page 1 of a website displays a number of pages 2-5 designed to conduct one or more processes. Typically, these processes are related, such as by a user job function or a specified task. A user may select parts page 2, for example, to execute a query on a part name or number. A user may select orders page 3 to query information on orders. A reports page 4 may provide general information on purchases and orders and a supplier page 5 may provide part delivery information from one or more suppliers. As a user selects any one of these pages, a routine executes and displays the requested page. The application may be designed to restrict user's access to particular pages, for example, pages related to the users employment.

As shown in FIG. 6 when a request from the request module 20 is sent to the library module 30 it is passed through, without any manipulation, to the data base 100. The request is processed in and data is retrieved or obtained from the data base 100. The so-obtained data is then sent or returned to the library module 30 whereat the pre-defined data fields or data points exist. The library module then transmits this data to the request module 20 where it is re-formatted. Then, the request module 20 deploys the re-formatted data for display. The pre-definitions for the data points or fields are stored in the library module. The first pre-definition data point(s) or field(s) is also stored in the library module along with a first data field format module. A second or third pre-definition data point(s) and respective format modules are stored in the request module.

For purposes of example only the following illustration will assume a user selects the parts page 2. Referring now to FIG. 2, a simplified architectural block diagram is shown of an embodiment of the computer program of the present invention. A request module 20 for executing a request for information from a database is executed when the program 10 receives a command to retrieve information. The request includes at least one procedure, which contains at least one database query. It should be noted however that the query may return a null set. The procedure will pass at least one parameter, for example, Part_search. A library module 30 receives the request from the request module 20. The library module 30 contains instructions to execute the procedures received from the request module 20.

In the preferred embodiment the computer program is installed on a server based system that executes a script, such as an active server page, which creates a request document. The request document contains the data necessary to execute one or more stored procedures in a database management system. The request document may be a well-formed XML document. Here the script sends the request document to a library function, which is a COM component. The COM component initializes an XML answer document. The answer document will contain all of the data returned by the database procedures.

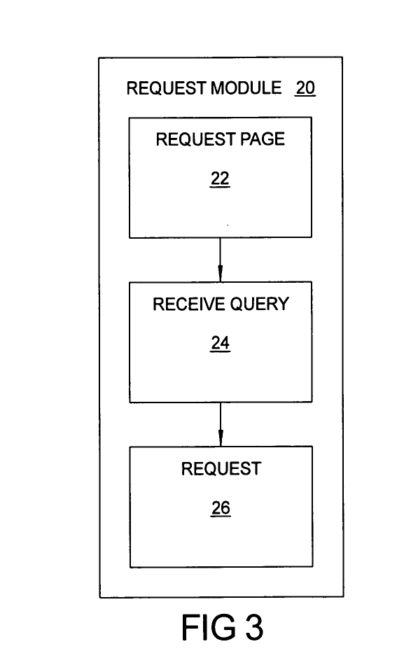

Referring now to FIG. 3, a simplified process flow diagram illustrates the request module 20 in accordance with the principles of the present invention. The request module 20 includes request page 22. When the page 22 is requested, a query 24 is sent to the module 20 which executes a request 26. In the immediate example request page is parts page 2. The request module 20 will pass the parameter Part_search to the library module 30 when the module 20 detects a query request 24. Part_search has an input parameter—partkeyfield_which may expect, for example, a part number entered by a client browser request.

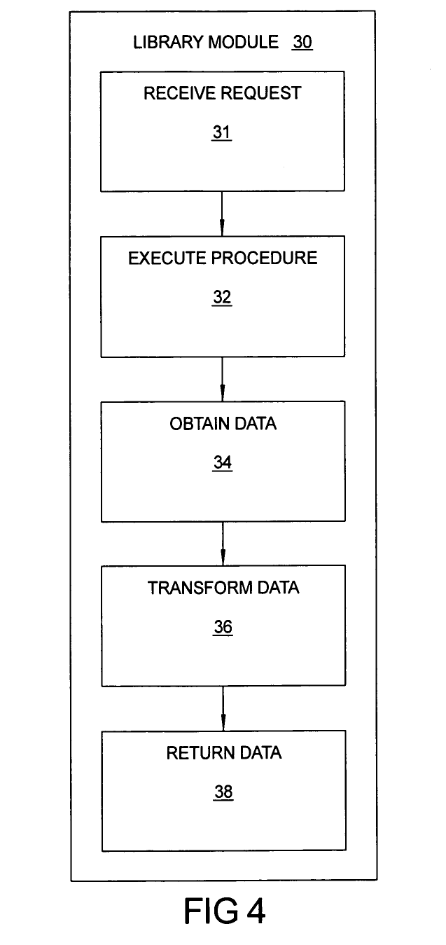

Referring now to FIG. 4 a simplified process flow diagram is shown illustrating the library module 30 in accordance with the principles of the present invention. The library module 30 receives a request 31 from the request module 20 to execute at least one procedure. The library module 30 will execute the procedure 32 and obtain data 34 from the database. The library module 30 then transforms the data 36 based upon instructions from a first data format module. The first data format module contains instructions to remove unnecessary data obtained by the query, add data identifiers, provide statistical information and arrange fields. The library module 30 will continue to execute procedures received from the request module 20 until all procedures have been executed. The library module 30 will then return data 38 to the request module 20.

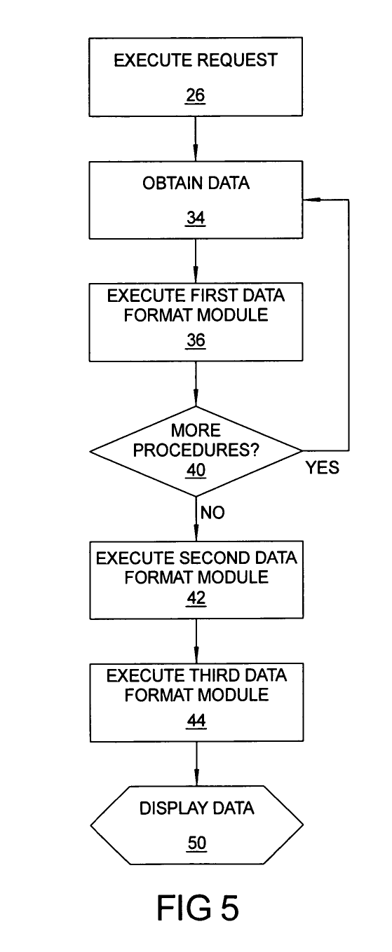

Referring now also to FIG. 5, a process flow diagram reveals a method for retrieving information from a database in accordance with the principles of the present invention. The request module 20 will execute a request 26, commanding the library module 30 to obtain data 34 from the database. The library module 30 will transform the data 34 according to instructions in the first data format module 36. The library module 30 will determine if there are more procedures to execute 40. The library module 30 will continue to execute procedures received from the request until all procedures are processed. The library module 30 will then return transformed data 38 to the request module 20. The request module 20 then transforms data received from the library module 30 based upon instructions from a second data format module 42 to create hierarchical relationships and attributes based upon received data fields. The request module 20 then transforms the data received from the second data format module 42 using upon instructions from a third data format module 44 to create a page layout based upon the requested page. Finally, the requested information is displayed 50 to the client or user.

The present invention by predefining the data point eliminates the need to create specific library modules for the data requests. The predefining, in essence, assigns, formats and ascribes the relational data bases, i.e. the relationship of the data. The invention creates a library of the tables to enable the easy retrieval of data for display on the website. The library, itself, specifies how to display data on the website, i.e. via spreadsheet or otherwise.

In a specific embodiment hereof, a predefinition is given to a data point, for example, “part sale”. Because the website uses “Part Sale” and it is defined in a library, in writing code by just inserting the phrase “Part Sales” in the part number, the application writer will then see displayed on the screen a currency with a dollar sign. Thus, there is no need to write a string of code.

By using the predefinition for the data point, in addition to the facilitation of creation of library modules and requests, there is no longer the need for individual “fetch” requests thus allowing savings in programming time.

It is to be appreciated that the present invention, by pre-defining the data point(s), standardizes the format and relationship of data including the parent, child and sibling relationships between data fields. Because of the pre-definition there is a single access routine for each piece of data.

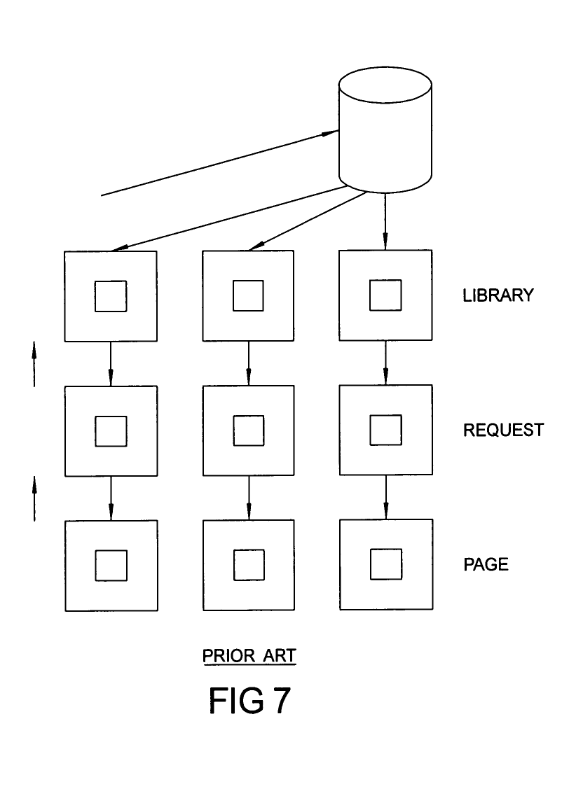

This is contrasted with the prior art method as shown in FIG. 7 where each page has its own dedicated request and library module in communication with the database thus requiring a string of code each time a request is to be processed.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

1. In a method for creating application software, of the type wherein data regarding an item is stored in a plurality of libraries pursuant to a request sent from a request module, the improvement which comprises:
(a) predefining at least a first data point;
(b) storing the at least first data point in the request module and the library;
(c ) storing the data point in at least one table in the request module, and wherein upon entering a request, the request communicates with the library, which, in turn, communicates with the data base to facilitate the display of the data point on a computer screen.

2. The method of claim 1 which further comprises:
(a) retrieving data from the data base and storing it in the library,
(b) sending the data to the request module,
(c) transforming the data in the request module, and
(d) sending the transformed to the display.

3. The method of claim 2 wherein the display is a website page.

4. A computer program for retrieving information from a database comprises:
(a) a request module for executing a request for information stored in a data base, the request module including at least one pre-defined data point,
(b) a library module for receiving the request and for obtaining data from a data base, the library module containing instructions to execute at least one procedure received from the request module and including means for returning transformed data from the database to the request module,
(c) a data base for storing data, and
(d) a first data format module for providing instructions to the library module, the first data format stored in the library.

5. The computer program of claim 4 which further comprises:
a display.

6. The computer program of claim 4 which further comprises:
means for displaying the returned transformed data on a website.

7. The computer program of claim 4 wherein the library module comprises:
means for obtaining data from the database, and
a first data format module including the first pre-definition data point.

8. The computer program of claim 4 which further comprises:
a second data format module associated with the request module to create hierarchical relationships and attributes based upon received data fields within the request module.

9. The computer program of claim 4 which further comprises:
a third data format module associated with the request module for providing instructions to the request module for enabling the request module to transform received data to create a page layout based upon a request page.

10. A method for retrieving information from a database which comprises the steps of:
(a) executing a request for information stored in a database, where the request includes at least one or more database procedures,
(b) processing the request by executing each procedure and obtaining data from the database,
(c) transforming obtained data based upon instructions from a first data format module,
(d) continuing to process procedures until all procedures have been processed and returning the transformed data to a display.

11. The method of claim 8 which further comprises:
transforming data at the request module received from the library module based upon instructions from a second data format module to create hierarchical relationships and attributes based upon received data fields.

12. The method of claim 8 which further comprises:
transforming data in the request module based upon instructions from a third data format module to create a page layout based upon a request page.

13. The method of claim 8 wherein:
the procedure received by the library module contains at least one database query.

14. The method of claim 8 wherein:
the display is a website.
